(19) United States
(12) Patent Application Publication
(10) Pub. No.: US 2025/0070364 A1
(43) Pub. Date: Feb. 27, 2025

(54) SCALABLE BATTERY MOUNTED LOCK OUT DEVICE

(71) Applicant: Caterpillar Inc., Peoria, IL (US)

(72) Inventor: Brian R. BELL, West Lafayette, IN (US)

(73) Assignee: Caterpillar Inc., Peoria, IL (US)

(21) Appl. No.: 18/238,357

(22) Filed: Aug. 25, 2023

(51) Int. Cl. H01M 50/264; H01M 50/249; H01M 50/258

(52) U.S. Cl. CPC H01M 50/264; H01M 50/249; H01M 50/258; H01M 2220/20

(57) ABSTRACT

A battery lock out system for a work machine, having a manual service disconnect configured to be attached to a power module of a battery pack for providing electrical power to the work machine, a service plug configured to be attached to the power module once the manual service disconnect has been removed from the power module, and a locking bracket sliding between a first position and a second position, the locking bracket including a first tab configured to lock a cover of the battery pack while the locking bracket is in the first position, and a second tab configured to lock the service plug onto the power module while the locking bracket is in the second position and the manual service disconnect has been replaced with the service plug.

### TECHNICAL FIELD

The present disclosure generally relates to work machines, and more specifically relates to battery systems for work machines.

### BACKGROUND

Mobile work machines such as dump trucks, excavators, track type tractors and the like may be used in heavy industries such as mining, construction, and others to transport materials and personnel. These work machines are often large in size, and require an operator, e.g., a driver, to manually operate the machine in order for the machine to perform its designated/intended operations.

Work machines, and especially those powered by electric motors, require large battery packs to provide electrical power to the work machine. The battery packs may be formed as an enclosure housing a plurality of battery modules connected to a single power module sitting on an exterior of the enclosure.

Large work machines may require a great amount of electrical power and as such, the battery packs may be configured to deliver the electrical power in various capacities such as 750 volts, 1500 volts, or any other capacities as known and required. These capacities may be delivered through a single battery pack, or through a string of battery packs. Common configurations include strings of two to four battery packs, among others.

Electrical power of this magnitude may be harmful to humans, and may particularly present a hazardous environment to those servicing the battery packs, or any electrical systems of the work machine. Accordingly, the battery packs may be provided with a manual service disconnect on each power module of the battery pack. The manual service disconnect may provide a simple mechanism to provide electrical continuity between the battery pack and the electrical systems of the work machine. The manual service disconnect may take the form of a cap on the power module that, once removed from the battery pack, breaks the electrical continuity. However, once the manual service disconnect is removed, a risk of accidental discharge of the battery pack remains.

In light of the aforementioned shortcomings, there is a need for a work machine with a battery lock out system that adequately covers the power module of the battery packs when the manual service disconnects have been removed. There is also a need for a work machine with a battery lock out system that can easily be scaled to work machines with strings of battery packs.

### SUMMARY OF THE DISCLOSURE

In accordance with one aspect of the disclosure, a work machine may be provided. The work machine may have a frame, a ground engaging member supporting the frame, an engine supported by the frame, a control module configured to control operation of the work machine, and a battery pack for providing electrical power to the work machine, the battery pack having a power module. The work machine may have a battery lock out system. The battery lock out system may include a manual service disconnect configured to be removably attached to the power module and providing electrical continuity to the battery pack. The battery lock out system may include a service plug configured to be removably attached to the power module once the manual service disconnect has been removed from the power module. The battery lock out system may include a locking bracket sliding between a first position and a second position, the locking bracket including a first tab configured to lock a cover of the battery pack while the locking bracket is in the first position, and a second tab configured to lock the service plug onto the power module while the locking bracket is in the second position and the manual service disconnect has been replaced with the service plug.

In accordance with another aspect of the disclosure, a battery lock out system for a work machine may be provided. The battery lock out system may have a manual service disconnect configured to be attached to a power module of a battery pack for providing electrical power to the work machine. The battery lock out system may have a service plug configured to be attached to the power module once the manual service disconnect has been removed from the power module. The manual service disconnect may have a locking bracket sliding between a first position and a second position, the locking bracket including a first tab configured to lock a cover of the battery pack while the locking bracket is in the first position, and a second tab configured to lock the service plug onto the power module while the locking bracket is in the second position and the manual service disconnect has been replaced with the service plug.

In accordance with yet another aspect of the disclosure, a method for servicing a battery pack of a work machine may be provided. The method may include placing the work machine in a powered-off state and removing a manual service disconnect from a power module of the battery pack of the work machine. The method may include placing a service plug on the power module in place of the manual service disconnect. The method may include sliding a locking bracket from a live position to a locked out position, removing a cover of the battery pack, and servicing a battery component of the battery pack. The method may include replacing the cover of the battery pack, sliding the locking bracket from the locked out position to the live position, removing the service plug from the power module, returning the manual service disconnect to the power module, and powering the work machine on.

These and other aspects and features of the present disclosure will be more readily understood when read in conjunction with the accompanying drawings.

### BRIEF DESCRIPTION OF THE DRAWINGS

FIG. 1 is a perspective view of a work machine constructed in accordance with an embodiment of the present disclosure.

FIG. 2 is a perspective view of a battery pack constructed in accordance with an embodiment of the present disclosure.

FIG. 3 is a perspective view of a battery pack with a manual service disconnect connected the battery pack constructed in accordance with an embodiment of the present disclosure.

FIG. 4 is a perspective view of a battery pack with the manual service disconnect removed from the battery pack and a service plug installed in its place, constructed in accordance with an embodiment of the present disclosure.

FIG. 5 is a perspective view of a service plug, constructed in accordance with an embodiment of the present disclosure.

FIG. 6 is an exploded view of a locking bracket, constructed in accordance with an embodiment of the present disclosure.

FIG. 7 is a perspective view of a string of battery packs, constructed in accordance with an embodiment of the present disclosure.

FIG. 8 is a flowchart depicting a sample sequence of steps for servicing a battery pack of a work machine which may be practiced in accordance with the work machine of the present disclosure.

### DETAILED DESCRIPTION

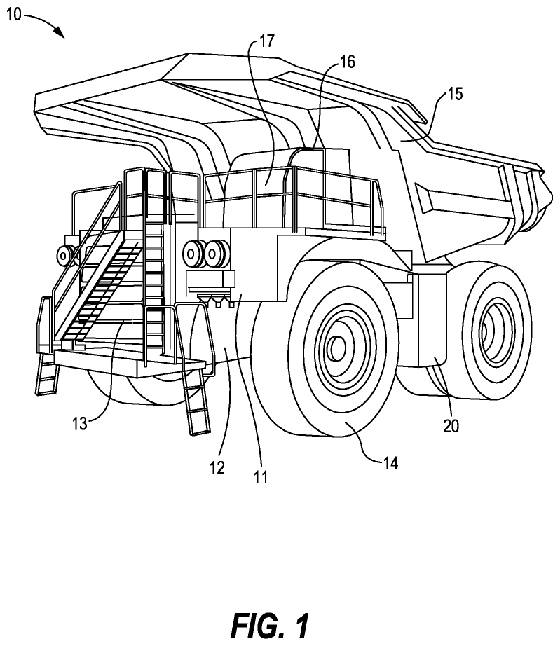

Referring now to the drawings, and with specific reference to FIG. 1, a work machine is depicted and generally referred to using reference numeral 10. The work machine 10 is exemplarily embodied in the form of a mining truck. While the work machine 10 is depicted as a mining truck, it should be noted that a type of machine used is merely exemplary and illustrative in nature. It will be acknowledged that the teachings of the present disclosure can be similarly applied to other types of work machines including but not limited to off highway trucks, excavators, track-type tractors, and other types of work machines known to persons skilled in the art.

Mining machines are used to transport materials within mining sites. The exemplary work machine 10 is supported by a frame 11. The work machine 10 may include a drivetrain 12 powered by a engine 13 and driving ground-engaging members 14 contacting the ground and supporting the frame 11 in order to operate the work machine 10. The work machine 10 may also include an implement 15 to perform a work job. In the view of FIG. 1, since the work machine 10 is a mining truck, the implement 15 is exemplarily depicted as a dump body, but with other machines the implement may be other types of work implements known to persons skilled in the art. The work machine 10 may also include an operator cabin 16 for an operator to control the operation of the work machine 10. The operator cabin 16 may include a control module 17 for the operator to use to direct the work machine 10. The work machine may also include a battery pack 20 in order to power the electrical systems of the work machine 10.

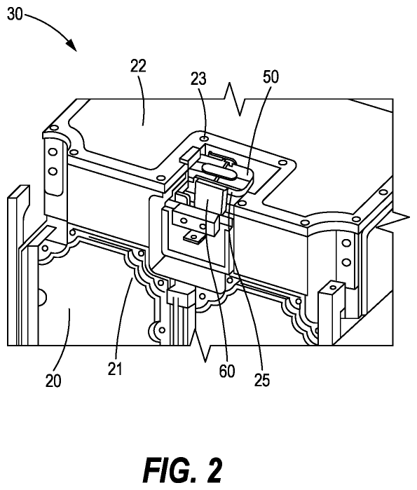

FIGS. 2-4 depict an exemplary embodiment of a battery pack 20 of the present enclosure, fitted with an exemplary embodiment of a battery lock out system 30. The battery pack 20 is formed by a battery enclosure 21 housing a plurality of battery modules (not pictured). The plurality of battery modules may configured such that the battery pack 20 may deliver the electrical power in various capacities such as 750 volts, 1500 volts, or any other capacities as know and required. In order to service the plurality of battery modules, the battery pack 20 has a battery cover 22. The battery cover 22 includes cover holes 23 which allow for cover bolts 24 to fit through and removably attach the battery cover 22 to the battery enclosure 21. A power module 25 is attached to the battery enclosure 21 and connected to the plurality of battery modules within the battery enclosure 21.

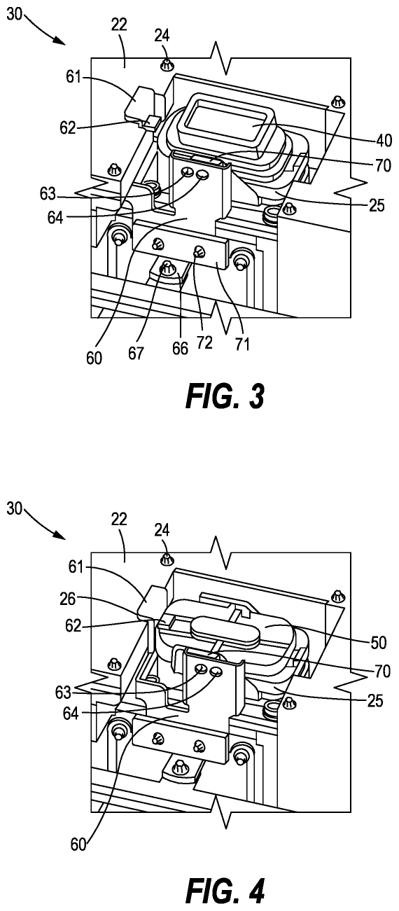

In the normal course of operation of the work machine 10, as depicted in FIG. 3, a manual service disconnect (MSD) 40 may bridge electrical connection point between the battery pack 20, and the electrical systems of the work machine 10. The MSD 40 may be configured to be removable, such that when service is required for components of the battery pack 20, the work machine 10 may be disconnected from electrical power. The MSD 40 may sit on top of the power module 25 as a cap as depicted in the embodiment of FIG. 3.

The battery lock out system 30 may be provided such that electrical connections on the power module 25 may be further isolated, and electrical discharge cause by accidentally bridging the connection points of the battery pack 20 may be avoided. The battery lock out system 30 may primarily include a service plug 50 and a locking bracket 60.

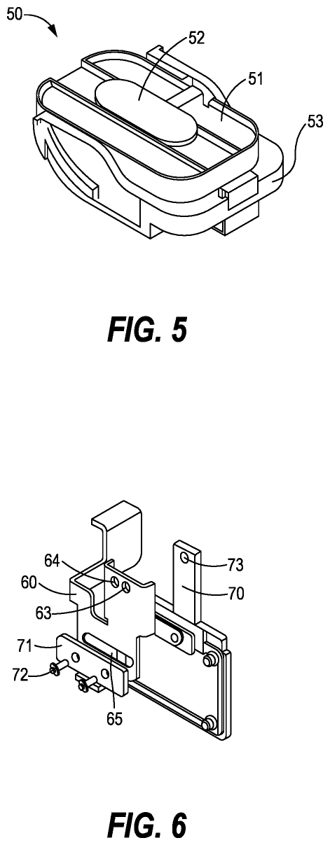

The service plug 50 is depicted in use in the work machine 10 in FIG. 4, and isolated in FIG. 5. The service plug 50 may be configured to replace the MSD 40 on top of the power module 25 of the battery pack 20 when the work machine 10 is shut down for service of the battery pack 20. The service plug 50 may be formed from a plug body 51, an electrical isolator 52, and a pack locking mechanism 53. The plug body 51 may be formed from a plastic material and may be configured to contain the electrical isolator 52, which may be formed from rubber. The electrical isolator 52 may come into direct contact with the electrical connections of the power module 25 and provide a barrier from contact with the electrical connections. The pack locking mechanism 53 may be configured to swing from an open position to a closed position as shown in FIGS. 3 and 5, and thus lock the service plug 50 to the power module 25. While the materials used to manufacture the service plug 50 may be plastic and rubber as described, any other suitable materials as known may be utilized in their place.

The locking bracket 60 is depicted in FIGS. 3-4 and 7. The locking bracket 60 is generally L-shaped, and is sandwiched between a locking post 70 and a sandwich plate 71. The locking bracket 60 may include a slot 65 that permits the locking bracket 60 to slide, with sandwich bolts 72 fitting through the sandwich plate 71, the slot 65, and the locking post 70 to the battery enclosure 21. Thereby, the locking post 70 and the sandwich plate 71 are stationary, with the locking bracket 60 siding therebetween.

The locking bracket 60 may be configured to slide between a first position, as shown in FIG. 3 wherein the work machine 10 is powered on and in a live operating condition, and a second position, as shown in FIG. 4 wherein the work machine 10 is powered off and in a locked out condition. The locking bracket 60 may include a first tab 61 and a second tab 62 on an opposite end. In the first position, where the work machine 10 may be in a live operating condition and the MSD 40 may be placed on top of the power module 25, the first tab 61 may overlap the battery cover 22, thereby providing additional locking to the battery cover 22 such that it cannot be removed. In the second position, where the work machine 10 may be powered off, and the battery pack 20 may be placed in a locked out condition with the service plug 50 placed on top of the power module 25, the second tab 62 may overlap the service plug 50, thereby providing additional locking to the service plug 50. The battery cover 22 may be provided with a notch 26 such that when the locking bracket 60 is the second position, the battery cover 22 may be removed from the battery pack 20 without interference from the battery lock out system 30.

The locking post 70 may include a locking hole 73, and the locking bracket 60 may include a first hole 63 and a second hole 64 that may be similarly dimensioned to the locking hole 73. When the locking bracket 60 is in the first position, the first hole 63 and the locking hole 73 may be aligned. A padlock may be placed through both the first hole 63 and the locking hole 73 such that the locking bracket 60 is securely locked in the first position. Similarly, when the locking bracket 60 is in the second position, the second hole 64 and the locking hole 73 may be aligned. Similarly, a padlock may be placed through both the second hole 64 and the locking hole 73. While this additional locking may be accomplished via a padlock as described, any similar physical lock as known may be utilized, and the locking hole 73, the first hole 63, and the second hole 64 may be accordingly be dimensioned to accommodate similar physical locks.

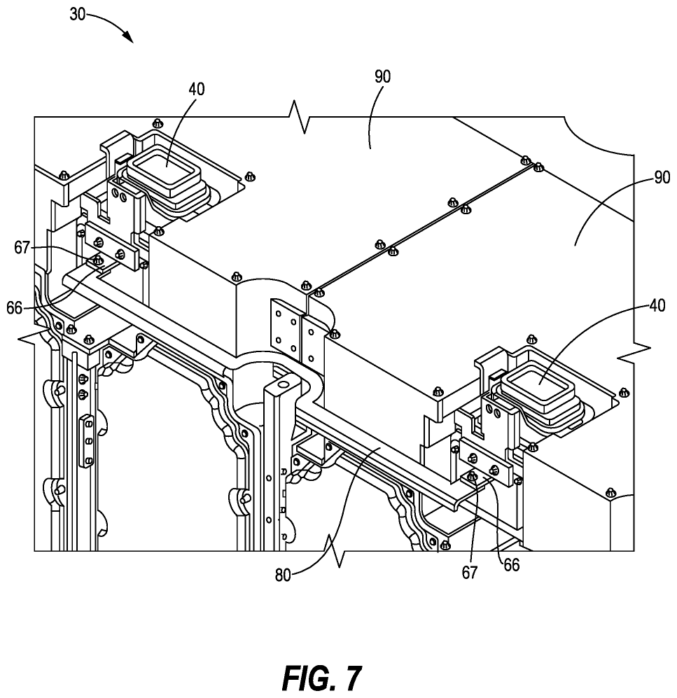

As noted above, large work machines may require a great amount of electrical power and as such, the battery pack 20 may be configured to deliver the electrical power in various capacities such as 750 volts, 1500 volts, or any other capacities as known and required. These capacities may be delivered through a single battery pack 20, or through a string of battery packs 90. Common configurations include strings of two to four battery packs 20, among others. Where the work machine 10 includes a string of battery packs 90 as depicted in FIG. 7, a locking bar 80 may be provided. Each battery pack 20 in the string of battery packs 90 may require corresponding locking brackets 60. In order to actuate each of the locking brackets 60 simultaneously and uniformly, the locking bracket 60 may be provided with a bar tab 66. The bar tab 66 of each of the locking brackets 60 may be attached to the locking bar 80 such that by manipulating just the locking bar 80, all of the locking brackets 60 may be moved from the first position to the second position. As depicted in FIG. 7, the bar tab 66 and the locking bar 80 are connected by the use of bolts 67, however, any other suitable fastening means as known may be utilized.

### INDUSTRIAL APPLICABILITY

In operation, the teachings of the present disclosure can find applicability in many industries including but not limited to work machines used in the earth moving, mining, agricultural, and construction industries. While depicted and described in conjunction with a mining machine, such teachings can also find applicability with other machines such as off highway trucks and the like.

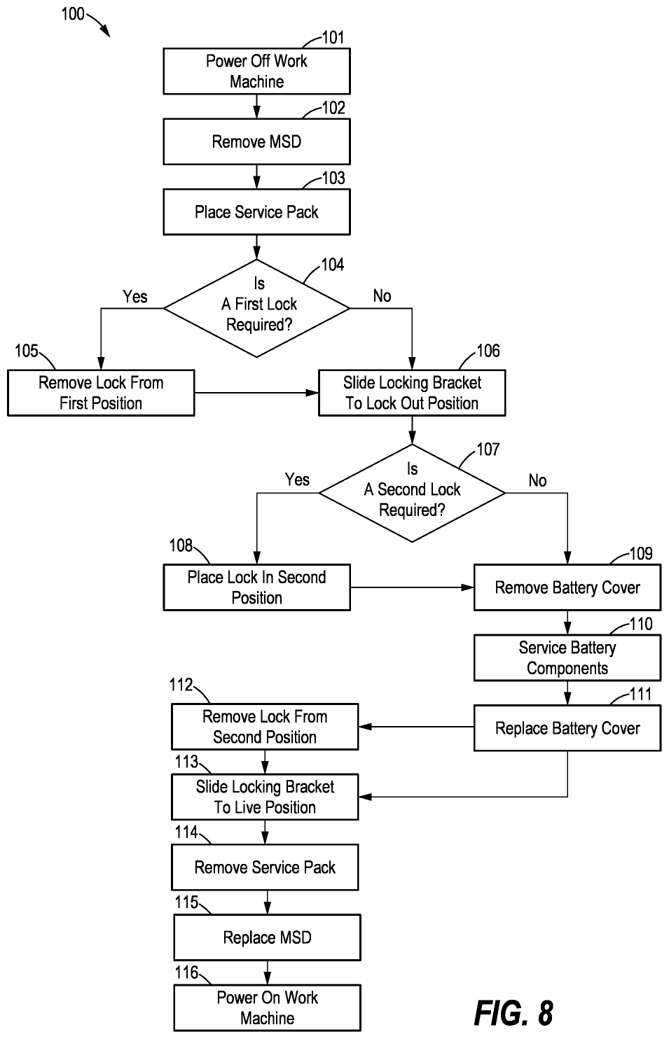

FIG. 8 illustrates a visual representation of a method 100 of servicing the battery pack 20 of the work machine 10. In a first step 101, the work machine 10 is placed in a powered off state. The battery pack 20 is then disconnected from the electrical systems of the work machine 10 in a second step 102, by removing the MSD 40 from the power module 25 of the battery pack 20. The battery pack 20 is then fully electrically protected from accidental discharge in a third step 103 by placing the service plug 50 on the power module 25.

In a fourth step 104, an operator performing service on the battery pack 20 must determine is proper procedure has required the use of locks on the locking bracket 60 to further lock the battery lock out system 30 between positions. If so, in a fifth step 105, the lock may be removed from the first hole 63 of the locking bracket 60 and the locking hole 73 of the locking post 70. Subsequently the locking bracket 60 may be slid from the first, live position, to the second locked out position in a sixth step 106.

Again, proper procedure for operators performing service on the battery pack 20 may dictate the re-use of locks to lock the locking bracket 60 in the second position during service. In a seventh step 107, the operator may determine if re-use of the lock is required, and in an eighth step 108, may place the lock through the second hole 64 of the locking bracket and the locking hole 73 of the locking post 70. Then, in a ninth step 109, the battery cover 22 of the battery pack 20 may be removed. In a tenth step 110, the necessary service on components of the battery pack 20 may be performed, and once service has been completed, in an eleventh step 111, the battery cover 22 may be re-attached.

The reverse operation may then be performed. In an twelfth step 112, the lock of the eighth step 108 may be removed. The locking bracket 60 may then be slid in a thirteenth step 113 back form the second locked out position to the first live position. In a fourteenth step 114, the service plug 50 may be removed from the power module 25 and in a fifteenth step 115, may be replaced with the MSD 40. In a final step 116, the work machine 10 may be powered back on.

The method 100 of servicing the battery pack 20 of the work machine 10 allows for additional protection of the battery pack 20 during servicing of the components such that accidental discharge of the battery pack 20 does not occur. The battery lock out system 30 may be designed into to the work machine 10 during initial manufacture of fully electric, or partially electric powered work machines alike.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A work machine, comprising:
a frame;
a ground engaging member supporting the frame;
an engine supported by the frame;
a control module configured to control operation of the work machine;
a battery pack for providing electrical power to the work machine, the battery pack having a power module; and
a battery lock out system, the battery lock out system including:
a manual service disconnect configured to be removably attached to the power module and providing electrical continuity to the battery pack;
a service plug configured to be removably attached to the power module once the manual service disconnect has been removed from the power module;
a locking bracket sliding between a first position and a second position, the locking bracket including a first tab configured to lock a cover of the battery pack while the locking bracket is in the first position, and a second tab configured to lock the service plug onto the power module while the locking bracket is in the second position and the manual service disconnect has been replaced with the service plug.

2. The work machine of claim 1, further comprising a locking post attached to the battery pack configured to lock the locking bracket between the first position and the second position.

3. The work machine of claim 2, wherein the locking post includes a hole at a top portion, and the locking bracket includes a first hole and a second hole located in a manner that the hole of the locking post is concentric with the first hole when the locking bracket is in the first position, and concentric with the second hole when the locking bracket is in the second position.

4. The work machine of claim 3, wherein the hole of the locking post and the first hole and the second hole of the locking bracket are sized such that a padlock may be fit through the hole of the locking post and one of the first hole or the second hole.

5. The work machine of claim 1, wherein the battery pack is formed by a string of battery packs.

6. The work machine of claim 5, wherein each of the string of battery packs includes the manual service disconnect, the service plug, and the locking bracket.

7. The work machine of claim 6, wherein the locking bracket further includes a bar tab such that a locking bar may be attached to the bar tab of each of the locking brackets of the string of battery packs and all of the locking brackets may be actuated by manipulating the locking bar.

8. A battery lock out system for a work machine, comprising:
a manual service disconnect configured to be attached to a power module of a battery pack for providing electrical power to the work machine;
a service plug configured to be attached to the power module once the manual service disconnect has been removed from the power module; and
a locking bracket sliding between a first position and a second position, the locking bracket including a first tab configured to lock a cover of the battery pack while the locking bracket is in the first position, and a second tab configured to lock the service plug onto the power module while the locking bracket is in the second position and the manual service disconnect has been replaced with the service plug.

9. The battery lock out system of claim 8, further comprising a locking post attached to the battery pack configured to lock the locking bracket between the first position and the second position.

10. The battery lock out system of claim 9, wherein the locking post includes a locking hole on a top portion.

11. The battery lock out system of claim 10, wherein the locking bracket includes a first hole and a second hole located in a manner that the locking hole is concentric with the first hole when the locking bracket is in the first position, and concentric with the second hole when the locking bracket is in the second position.

12. The battery lock out system of claim 11, wherein the battery lock out system is dimensioned such that a padlock may be placed through the locking hole and either of the first hole or the second hole of the locking bracket such that the locking bracket is locked in either the first position or the second position.

13. The battery lock out system of claim 8, wherein the battery pack is formed by a string of battery packs, each of the string of battery packs including one each of the manual service disconnect, the service plug, and the locking bracket.

14. The battery lock out system of claim 13, further comprising a locking bar configured to be attached to each of the locking brackets of the string of battery packs such that moving the locking bar causes movement of each of the locking brackets.

15. A method for servicing a battery pack of a work machine; comprising:
placing the work machine in a powered-off state;
removing a manual service disconnect from a power module of the battery pack of the work machine;
placing a service plug on the power module;
sliding a locking bracket from a live position to a locked out position;
removing a cover of the battery pack;
servicing a battery component of the battery pack;
replacing the cover of the battery pack;
sliding the locking bracket from the locked out position to the live position;
removing the service plug from the power module;
returning the manual service disconnect to the power module; and
powering the work machine on.

16. The method of claim 15, wherein:
the step of removing the manual service disconnect further includes removing the manual service disconnect from each of a string of battery packs;
the step of placing the service plug further includes placing the service plug on each of the power modules of the string of battery packs; and
the step of sliding the locking bracket further includes sliding each of the locking brackets on each of the string of battery packs.

17. The method of claim 16, wherein the steps of sliding the locking bracket further includes sliding a locking bar connected to each of the locking brackets such that sliding the locking bar actuates all of the locking brackets uniformly and simultaneously.

18. The method of claim 17, wherein:
the step of removing the service plug further includes removing the service plug on each of the power modules of the string of battery packs; and
the step of replacing the manual service disconnect further includes replacing the manual service disconnect from each of the string of battery packs.

19. The method of claim 15, further comprising:
prior to the step of removing the cover of the battery pack, placing a padlock through a locking hole of a locking post attached to the battery pack and a hole of the locking bracket such that the locking bracket is fixed in the locked out position; and
prior to the step of replacing the cover of the battery pack, removing the padlock from the locking post and the locking bracket.

20. The method of claim 15, further comprising:
prior to the step of sliding the locking bracket from the live position to the locked out position, removing a padlock from a locking hole of a locking post attached to the battery pack and a hole of the locking bracket;
prior to the step of sliding the locking bracket from the locked out position to the live position, placing the padlock through both the locking hole of the locking post and the hole of the locking bracket such that the locking bracket is fixed in the live position.
